(19) United States
(12) Patent Application Publication
(10) Pub. No.: US 2023/0382087 A1
(43) Pub. Date: Nov. 30, 2023

(54) GLASS LAMINATES WITH REDUCED CREEP AT ELEVATED TEMPERATURE

(71) Applicant: KURARAY EUROPE GMBH, Hattersheim (DE)

(72) Inventors: Charles Anthony SMITH, Houston, TX (US); Stephen BENNISON, Houston, TX (US)

(73) Assignee: KURARAY EUROPE GMBH, Hattersheim (DE)

(21) Appl. No.: 18/028,269

(22) PCT Filed: Sep. 21, 2021
(86) PCT No.: PCT/EP2021/075977

§ 371 Date: Mar. 31, 2023

Related U.S. Application Data
(60) Provisional application No. 63/084,239, filed on Sep. 28, 2020.

(51) Int. Cl. B32B 17/10

(52) U.S. Cl. CPC B32B 17/10761; B32B 17/10633

(57) ABSTRACT

This invention relates to a glass laminate containing an interlayer based on a specified ethylene vinyl acetate-based resin composition, which is particularly suitable for higher temperature applications where polymer creep can be an issue, such as overhead architectural glazing, spandrels and bolted laminate applications, and particularly for locations where the glazing temperature can exceed 50° C., and even 60° C., for an extended period.

### FIELD OF THE INVENTION

This invention relates to a glass laminate suitable for higher temperature applications where polymer creep can be an issue, such as overhead architectural glazing, spandrels, fins and bolted laminate applications, and particularly for locations where the glazing temperature can exceed 50° C., and even 60° C., for an extended period.

### BACKGROUND OF THE INVENTION

Laminated glass is widely used in windshields, side glass and rear glass of vehicles such as automobiles and aircraft, and as windows of buildings and the like, in part to reduce scatter fragments of glass even when damaged by receiving an external impact.

Recently, the demand for the performance improvement of laminated glass is increasing. In particular, when a laminated glass is used in a structural application (facade) of a building, it is required that the laminated glass prevents penetrate of a projectile even after glass breakage, and that the laminate has self-supporting properties even under high temperature conditions. In order to satisfy the required performance, it is necessary that the interlayer film have a desirable combination of adhesion and heat resistance so that it maintains an elastic modulus equal to or higher than a certain criterion.

As an intermediate film (interlayer) for laminated glass, a large amount of vinyl butyral resin is used, and a liquid plasticizer or an adhesive force adjusting agent is blended to adjust shaping workability, penetration resistance and adhesion to glass. By the blending of the liquid plasticizer, the vinyl butyral resin softens and the heat resistance is lowered. In addition, when the amount of the liquid plasticizer to be blended is reduced or not blended, although the heat resistance is improved, it is necessary to increase the shaping temperature because the molding processability is lowered. Such heating increases the color of both the interlayer and laminate.

JPS6379741A and JP2004068013A describe the use of a vinyl acetal-based polymer modified by a α-olefin in an interlayer film of laminated glass. However, in these inventions, such as the need to use a large amount of a plasticizer, the problems pointed out above have not been considered and have not led to improvement.

JP201157737A describes a sheet made of a polyvinyl acetal resin having an ethylene content of 0.5 to 40 mol % and an acetalization degree of 30 mol % or more. Note that 2 types of definitions are conventionally used for the degree of acetalization (as discussed in detail below), but a definition of the degree of acetalization is not described in JP201157737A. Therefore, the meaning of the degree of acetalization in JP201157737A cannot be confirmed without actual measurement. It has been explained that this sheet is highly transparent, strong, flexible and can be utilized for laminated glass.

However, in the example of JP201157737A, when a sheet is shaping, a large amount of triethyleneglycol-di-2-ethylhexanoate, that is, a plasticizer, of 30 parts by mass per 100 parts by mass of the above polyvinyl acetal resin is blended. When a large amount of a plasticizer is used, the heat resistance is remarkably lowered as previously pointed out. Further, since the degree of acetalization is 30 mol % or more, there is a problem in heat resistance.

JPH0930846A describes a laminated glass in which a thermosetting resin in which an organic peroxide and a silane coupling agent are blended into an ionomer resin in which intermolecular of a ethylene-methacrylic acid copolymer is bonded with metal ions is interposed between glass plates and integrated, and the resin layer is thermally cured. This laminated glass is obtained by improving impact resistance and penetration resistance of a conventional laminated glass using a polyvinyl butyral-based resin as an intermediate layer, and is described as excellent in impact resistance, penetration resistance, processability and transparency.

However, the ionomer resin tends to cause whitening or adhesion failure if the temperature condition at the time of molding is not strictly adjusted, and in particular, there is a problem that it tends to be whitened when the rate of cooling after melt molding decreases. For example, when a laminated glass in which a plate-like molded article of an ionomer resin is sandwiched is cooled, whitening occurs in a central portion where a cooling rate is slow, and transparency decreases. As described above, a laminated glass using an ionomer resin has strict control of manufacturing conditions, a high production cost, and it is difficult to industrially mass produce it.

### SUMMARY OF THE INVENTION

The present invention addresses the above problems by providing a glass laminate comprising an interlayer made of an ethylene-vinyl acetal resin composition, wherein:
(i) the ethylene-vinyl acetal resin composition comprises 80% by mass of a modified vinyl acetal resin component, based on the total mass of the ethylene-vinyl acetal resin composition;
(ii) the modified vinyl acetal resin component is one or more ethylene-vinyl acetal resins containing from 25 to 60 mol % of ethylene units and 24 to 71 mol % of vinyl alcohol units, based on all monomer units constituting the resin, and having an acetalization degree of from 5 mol % or more to less than 40 mol %; and
(iii) the glass laminate exhibiting a creep of less than 1.9 mm at 60° C. for 1 month, measured as set forth herein.

In one embodiment, the ethylene-vinyl acetal resin composition is substantially free of plasticizer, for example, 1% by mass or less of plasticizer based on the total mass of the ethylene-vinyl acetal resin composition.

In another embodiment, the acetyl groups of the ethylene-vinyl acetyl resin(s) are derived from one or more of butyraldehyde, benzaldehyde and isobutyraldehyde.

In one embodiment, the interlayer comprises an extruded film or sheet of the ethylene-vinyl acetal resin composition.

The glass laminates in accordance with the present invention provide a desirable combination of flexural strength, stiffness, optical and creep properties, particularly at elevated temperatures in excess of 50° C., or at 60° C. (or even higher), and are thus suitable for use in a variety of architectural and other end uses.

Accordingly, in one embodiment, the glass laminate is an overhead glazing.

In another embodiment, the glass laminate is a spandrel.

In another embodiment, the glass laminate is a glass fin.

In another embodiment, the glass laminate is a bolted glazing.

These and other embodiments, features and advantages of the present invention will be more readily understood by those of ordinary skill in the art from a reading of the following detailed description.

### BRIEF DESCRIPTION OF THE DRAWINGS

FIG. 1 is a graph showing the relation between the degree of acetalization (DA1) in the ethylene-vinyl acetal resins used in present invention versus the assumed degree of acetalization (DA2) in JP201157737A.

### DETAILED DESCRIPTION

This invention relates to glass laminates suitable for higher temperature applications, said glass laminates containing a plastic interlayer of a particular ethylene vinyl acetal-based resin composition as further described in detail below.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

In certain instances, a quantitative value set forth herein may be determined by an analytical or other measurement method that is defined by reference to a published or otherwise recognized standard procedure. Typical examples of sources of such recognized standard procedures include ASTM (American Society for Testing Materials, now ASTM International); ISO (International Organization for Standardization); DIN (Deutsches Institut fur Normung); and JIS (Japanese Industrial Standards). Unless clearly stated otherwise herein, the specific standard procedure used herein is considered to be the version of that procedure that is in force on the filing date of this application.

In the context of the present invention, laminate “creep” is defined as the deflection of a rectangular laminated glass beam in a four-point bend test. The four-point bend test is based on ISO 1288-3:2016, with some modifications to the sample size, loading/support span dimensions, test temperature and load application rate. The four-point bend test consists of loading a rectangular laminated glass sample, planar dimensions 305 mm×610 mm, loaded on a 150 mm span and supported on a 300 mm span. The sample is maintained at a temperature of 60° C. and a fixed load of 1 kN is applied for one month. The deflection of the laminate is monitored at the beam center-point on the supported surface. For a laminate consisting of 3 mm glass+0.76 mm interlayer+3 mm glass, the maximum laminate deflection in accordance with the invention is less than 1.9 mm under these test conditions.

“MFR” means “melt flow rate” which, unless otherwise specified, is a measured value at a temperature of 190° C. and a load of 2160 g in accordance with HS K 7210:2014.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When a range of values is stated as being “less than” or “no more than” a designated quantity (or other equivalent phrasing), it is to be understood that the range is bounded on the low end by an unspecified non-zero value. Correspondingly, when a range of values is stated as being “more than”, “greater than”, or “not less than” a designated quantity (or other equivalent phrasing), it is to be understood that the range on the high end is not infinite, and that it is bounded on the high end by an unspecified finite value.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of claim elements is not necessarily limited to only those elements but can include other elements not expressly listed or inherent to such process, method, article, or apparatus.

The transitional phrase “consisting of” excludes any claim element or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified claim elements, materials or steps and those others that do not materially affect the basic and novel characteristic(s) of the claimed invention. A “consisting essentially of” claim thus occupies a middle ground between closed claims that are written in a “consisting of” format, and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion”, as used herein, unless otherwise defined herein, means that greater than 50% of the referenced material. If not specified, the percent is on a molar basis when reference is made to a molecule (such as hydrogen, methane, carbon dioxide, carbon monoxide and hydrogen sulfide), and otherwise is on a weight basis (such as for carbon content).

The term “substantial portion” or “substantially”, as used herein, unless otherwise defined, means all or almost all or the vast majority, as would be understood by a person of ordinary skill in the relevant art in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising vinyl acetate and 15 mol % of a comonomer”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

As ascertainable from the context, the term “composition” will typically be used to refer to more than one polymer and/or copolymer together, and optionally other types of components blended or admixed therewith, but can permissibly also be used to refer to just one polymer or copolymer by itself.

The terms “film” and “sheet”, while interchangeable, can each be defined in terms of their thickness, although there is no set industry standard. As sometimes used herein, the term” film” may refer to a structure having a thickness of about 10 mils (0.25 mm) or less, and the term “sheet” may refer to a structure having a thickness of greater than about 10 mils (0.25 mm). Other meanings (thicknesses) may be given in the context of specific embodiments.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

For convenience, many elements of this invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### Ethylene-Vinyl Acetal Resin

The ethylene-vinyl acetal resin used in the present invention is obtained by subjecting an aldehyde to an acetalization reaction with an ethylene-vinyl alcohol resin (hereinafter, referred to as an ethylene-vinyl alcohol copolymer).

Examples of the ethylene-vinyl alcohol copolymer include those obtained by copolymerizing ethylene and a vinyl ester monomer and saponifying the obtained copolymer.

As a method for copolymerizing ethylene and a vinyl ester monomer, conventionally known methods such as solution, bulk, suspension and emulsion polymerization can be applied. As a polymerization initiator, an azo-based initiator, a peroxide-based initiator, a redox-based initiator, or the like is appropriately selected depending on the polymerization method.

In the saponification reaction, a conventionally known alkali catalyst or an acid catalyst can be used for alcoholysis, hydrolysis, and the like, and among them, a saponification reaction using a methanol as a solvent and a caustic soda (NaOH) catalyst is convenient.

Although there is no particular limitation on the degree of saponification of the ethylene vinyl alcohol copolymer, it is typically 95 mol % or more, or 98 mol % or more, or 99 mol % or more, or 99.9 mol % or more.

Examples of suitable vinyl ester monomers include vinyl formate, vinyl acetate, vinyl propionate, vinyl butyrate, vinyl isobutyrate, vinyl pivalate, vinyl versatile acid, vinyl caproate, vinyl caprylate, vinyl laurate, vinyl palmitate, vinyl stearate, vinyl oleate, vinyl benzoate, and the like. Vinyl acetate is preferred.

The ethylene unit of the ethylene vinyl alcohol copolymer is typically from 25 mol %, or from 30 mol %, or from 35 mol %, to 60 mol %, or to 55 mol %, or to 50 mol %. As the ethylene unit ratio decreases, the impact resistance of the modified vinyl acetal resin of the present invention tends to decrease. Conversely, when the ethylene unit ratio increases, the heat resistance tends to be negatively impacted. By satisfying the above range, the ethylene unit of the ethylene-vinyl acetal resin can be more specifically adjusted to achieve a suitable balance of properties.

The MFR of the ethylene vinyl alcohol copolymer at 190° C. and 2.16 kg load is generally from 1 g/10 min, or 2 g/10 min, or 3 g/10 min, to 30 g/10 min, or to 20 g/10 min, or to 10 g/10 min. By satisfying this range, the MFR of the modified vinyl acetal resin described later can be adjusted to a suitable range.

Although there is no particular limitation on the method for producing the ethylene-vinyl acetal resin used in the present invention, it can be produced by a known production method. Examples thereof include a method in which an aldehyde is added in an ethylene vinyl alcohol copolymer solution under acidic conditions and subjected to an acetalization reaction, or a method in which an aldehyde is added in an ethylene vinyl alcohol copolymer dispersion under acidic conditions and subjected to an acetalization reaction.

The reaction product obtained after the acetalization reaction is neutralized with alkali, and then washed with water and removed by solvent to obtain an intended modified vinyl acetal resin.

The solvent for producing the modified vinyl acetal resin is not particularly limited, and examples thereof include water, alcohols, dimethyl sulfoxide, and a mixed solvent of water and alcohols.

There is no particular limitation on the dispersion medium for producing the modified vinyl acetal resin, and examples thereof include water and alcohol.

The catalyst for carrying out the acetalization reaction is not particularly limited, and any of an organic acid and an inorganic acid may be used. Examples thereof include acetic acid, para toluenesulfonic acid, nitric acid, sulfuric acid, hydrochloric acid, carbonic acid, and the like. In particular, inorganic acids such as hydrochloric acid, sulfuric acid, and nitric acid are preferably used because they can be easily washed after the reaction.

The aldehyde used in the acetalization reaction is not particularly limited, and for example, formaldehyde, acetaldehyde, propionaldehyde, butyraldehyde, hexylaldehyde, benzaldehyde, isobutyraldehyde, 2-ethylhexylaldehyde, 2-methylbutyraldehyde, trimethylacetaldehyde, 2-methylpentyaldehyde, 2,2-dimethylbutyraldehyde, 2-ethylbutyraldehyde, 3,5,5-trimethylhexylaldehyde, or the like is used, and butyraldehyde, benzaldehyde and isobutyraldehyde are preferable in terms of heat resistance and optical characteristics. In addition, a single aldehyde may be used, or 2 or more of them may be used in combination.

The alkali used for neutralizing the reaction product is not particularly limited, and examples thereof include sodium hydroxide, potassium hydroxide, ammonia, sodium acetate, sodium carbonate, sodium hydrogen carbonate, and potassium carbonate.

The degree of acetalization of the modified vinyl acetal resin of the present invention is generally 5 mol % or more and less than 40 mol %. In various embodiments, the lower limit value of the degree of acetalization is 6 mol % or more, or 7 mol % or more, or 8 mol % or more, or 9 mol %, or 10 mol % or more. When the degree of acetalization is too low, the modified vinyl acetal resin has high crystallinity, so that transparency tends to be deteriorated. Further, in other embodiments, the upper limit value of the degree of acetalization is 38 mol % or less, or 36 mol % or less, or 34 mol % or less, or 32 mol % or less, or less than 30 mol %. Note that the upper limit value of the degree of acetalization may also be 29 mol % or less, or 28 mol % or less, or 27 mol % or less, or 26 mol % or less, or less than 25 mol %. When the degree of acetalization is too high, heat resistance and glass adhesiveness tend to be impaired.

As indicated above, two types of definition are commonly used for the degree of acetalization of ethylene-vinyl acetal resins. One is defined as the fraction of the acetalized vinyl alcohol unit among the structural units other than ethylene units. In other words, for example, it refers to the proportion of the acetalized vinyl alcohol unit in the sum of the acetalized vinyl alcohol unit, the non-acetalized vinyl alcohol unit, and the vinyl acetate unit. Such degree of acetalization is determined by the degree of acetalization

DA1(mol %)={k/(k+1+m)}×100

assuming that the mole fraction of the non-acetalized vinyl alcohol unit (1), the mole fraction of the vinyl acetate unit (m) and the mole fraction of the acetalized vinyl alcohol unit (k).

The other is defined as the fraction of the total monomeric unit, which also contains ethylene units, that is, acetalized vinyl alcohol units. In other words, for example, it refers to the ratio of the total of the ethylene unit, the acetalized vinyl alcohol unit, the non-acetalized vinyl alcohol unit, and the vinyl acetate unit to the acetalized vinyl alcohol unit. Such degree of acetalization is determined by the degree of acetalization

DA2(mol %)={k/(k+1+m+n)}×100

assuming that the mole proportion of the non-acetalized vinyl alcohol unit (1) and the mole proportion of the vinyl alcohol unit acetalized (m) are the mole proportion of the acetalized vinyl alcohol unit (k), the mole proportion of the ethylene unit (n).

In the present invention, the degree of acetalization employs the former DA1. In other words, the ratio of the acetalized vinyl alcohol unit among the structural units other than the ethylene unit is defined as the degree of acetalization.

Note that the relation between the degree of acetalization (DA1) and the degree of acetalization (DA2) is represented by the formula (I):

DA2={(100−n)/100}×DA1 (I)

In the formula (1), n indicates the molar ratio of ethylene unit to total monomer unit.

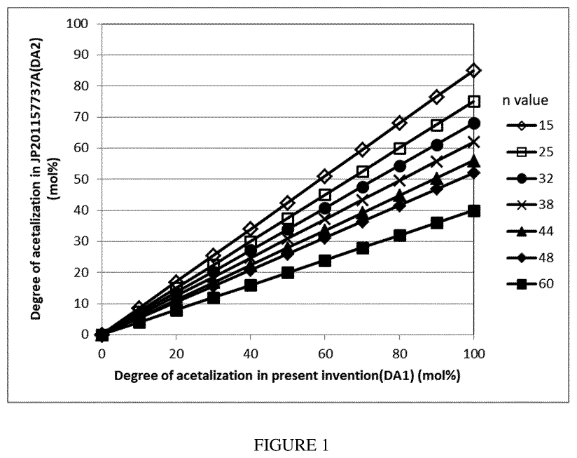

FIG. 1 is a graph showing the relation between the degree of acetalization (DA1) and the degree of acetalization (DA2) at n=15, 25, 32, 38, 44, 48, and 60, for example.

The degree of acetalization of the modified vinyl acetal resin of the present invention can be determined by the following procedure. First, a modified vinyl acetal resin is dissolved in ethanol, a 2N hydrochloride hydroxylamine solution and hydrochloric acid are added, and the mixture is stirred in a water bath under a condenser for 4 hours, and after cooling, ammonia water is added and neutralized, and then methanol is added and precipitated, followed by washing and drying to obtain an ethylene vinyl alcohol copolymer. Then, the obtained ethylene vinyl alcohol copolymer is dissolved in DMSO (dimethyl sulfoxide) at 120° C., cooled at room temperature, and then N,N-dimethyl-4-aminopyridine and acetic anhydride are added thereto, followed by stirring reaction for 1 hours, followed by precipitation with ion-exchanged water and acetone, and clean and drying to obtain an ethylene vinyl acetate copolymer.

The obtained ethylene vinyl acetate copolymer is dissolved in DMSO-d₆ and measured by a proton NMR measuring device of 400 MHz. From the spectrum obtained by measuring the number of times of integration 256 times, the molar ratio (n) of the ethylene unit of the ethylene vinyl alcohol copolymer can be calculated from the intensity ratio of the methine proton (peak of 1.1 to 1.9 ppm) derived from the ethylene unit and the vinyl acetate unit, and the terminal methyl proton (peak of 2.0 ppm) derived from the vinyl acetate unit.

The molar proportions (1) of vinyl alcohol units, molar proportions (m) of vinyl acetate units, and molar proportions (k) of acetalized vinyl alcohol units with respect to all monomer units making up the modified vinyl acetal resin are calculated from spectra obtained by dissolving the modified vinyl acetal resin in DMSO-d₆ and measuring with a 400 MHz proton NMR-spectrometer at 256 cumulative times, using the intensity ratio of ethylene units, vinyl alcohol units, and methyl protons derived from vinyl ester units (peaks of 1.0-1.8 ppm), and terminal methyl protons derived from acetal units (peaks of 0.8-1.0 ppm), and the molar proportions (n) of ethylene vinyl alcohol units copolymer.

The degree of acetalization of the modified vinyl acetal resin is determined by using the determined molar ratio of vinyl alcohol unit (1), the molar ratio of vinyl acetate unit (m), and the molar ratio of acetalized vinyl alcohol unit (k), and calculated using DA1.

Further, as another method, an ethylene vinyl alcohol copolymer prior to the acetalization reaction is dissolved in DMSO at 120° C., cooled at room temperature, and then N,N-dimethyl-4-aminopyridine and acetic anhydride are added thereto, followed by stirring reaction for 1 hour, followed by precipitation with ion-exchanged water and acetone, washing and drying, thereby obtaining an ethylene vinyl acetate copolymer.

The obtained ethylene vinyl acetate copolymer is dissolved in DMSO-d₆ and measured by a proton NMR measuring device of 400 MHz. From the spectrum obtained by measuring the number of times of integration 256 times, the molar ratio (n) of the ethylene unit of the ethylene vinyl alcohol copolymer can be calculated from the intensity ratio of the methine proton (peak of 1.1 to 1.9 ppm) derived from the ethylene unit and the vinyl acetate unit, and the terminal methyl proton (peak of 2.0 ppm) derived from the vinyl acetate unit. Note that, since the ethylene unit is not affected by the acetalization reaction, the molar ratio (n) of the ethylene unit of the ethylene vinyl alcohol copolymer before the acetalization reaction is equal to the molar ratio (n) of the ethylene unit of the modified vinyl acetal resin obtained after the acetalization reaction.

The molar proportions (1) of vinyl alcohol units, molar proportions (m) of vinyl acetate units, and molar proportions (k) of acetalized vinyl alcohol units with respect to all monomer units making up the modified vinyl acetal resin are calculated from spectra obtained by dissolving the modified vinyl acetal resin in DMSO-d₆ and measuring with a 400 MHz proton NMR-spectrometer at 256 cumulative times, using the intensity ratio of ethylene units, vinyl alcohol units, and methyl protons derived from vinyl ester units (peaks of 1.0-1.8 ppm), and terminal methyl protons derived from acetal units (peaks of 0.8-1.0 ppm), and the molar proportions (n) of ethylene vinyl alcohol units copolymer.

The degree of acetalization of the modified vinyl acetal resin may be determined by using the determined molar ratio of vinyl alcohol unit (1), the molar ratio of vinyl acetate unit (m), and the molar ratio of acetalized vinyl alcohol unit (k), and calculated using DA1.

As yet another method, according to the method described in JIS K6728:1977, the mass ratio of the vinyl alcohol unit not acetalized (l₀), the mass ratio of the vinyl alcohol unit acetalized (m₀) and the mass ratio of the vinyl alcohol unit acetalized (k₀) are determined by titration, respectively, and the mass ratio of the ethylene unit (no) is determined by n₀=1−l₀−m₀−k₀, and from this, the molar ratio of the vinyl alcohol unit not acetalized (1), the molar ratio of the vinyl acetate unit (m) and the molar ratio of the acetalized vinyl alcohol unit (k) are calculated, and the acetalization degree is calculated form DA1.

The vinyl alcohol unit of the modified vinyl acetal resin of the present invention is 24 to 71 mol % based on the total monomer unit constituting the resin. The lower limit of the mole ratio of the vinyl alcohol unit is more preferred in the order of 24.8 mol % or more, 25.6 mol % or more, 26.4 mol % or more and 27.2 mol % or more, and most preferred in the order of 28 mol % or more. Note that the lower limit value of the molar ratio of the vinyl alcohol unit may be 26 mol % or more, 32 mol % or more, or 38 mol % or more. When the proportion of the vinyl alcohol unit is less than 24 mol %, the modified vinyl acetal resin of the present invention tends to impair glass adhesion. Further, the upper limit of the morphological ratio of the cellular acol unit is 70.5 M % or less, 69.8 M or less, 69 M or less, more preferably in the order of 68.3 or less, 67.5% or less is most preferred. Note that the upper limit value of the molar ratio of the vinyl alcohol unit may be 65 mol % or less and 59 mol % or less. When the proportion of the vinyl alcohol unit is more than 71 mol %, the glass adhesion becomes high, but the transparency tends to be deteriorated.

The mol % based on the total monomer unit constituting the modified vinyl acetal resin of the present invention is calculated by converting 1 mol of the acetal unit into 2 mol of the vinyl alcohol unit. For example, an ethylene unit of a modified vinyl acetal resin consisting of 44.0 mol of ethylene units, 44.8 mol of vinyl alcohol units and 5.6 mol of acetal units is 44.0 mol %, a vinyl alcohol unit is 44.8 mol %, and an acetalization degree is 20.0 mol %

The MFR of the modified vinyl acetal resin of the present invention at 190° C. and 2.16 kg load is desirably on the order of from 0.1 g/10 min, or 1 g/10 min, or 2 g/10 min, or 3 g/10 min, to 100 g/10 min, or to 50 g/10 min, or to 30 g/10 min, or to 20 g/10 min. If the MFR is too low, sufficient processability in an appropriate molding temperature range at the time of molding processing (fluidity) is not obtained, it is necessary to increase the molding temperature, and the resulting molded body tends to be easily colored. If the MFR is too high, a sufficient melt tension cannot be obtained in an appropriate molding temperature range at the time of molding processing, and there is a tendency that problems such as film formation stability and deterioration of the surface state of the molded body tend to occur.

### Resin Composition

The resin composition used in the present invention preferably contains 80% by mass or more (including 100%), more preferably 90% by mass or more (including 100%), and still more preferably 95% by mass or more (including 100%) of one or a combination of modified vinyl acetal resins, based on the total mass of the resin composition.

In addition to the modified vinyl acetal resin, the resin composition of the present invention may optionally contain other thermoplastic resins. The other thermoplastic resin is not particularly limited, and examples thereof include a (meth) acrylic resin, a polyvinyl butyral-based resin, and an ionomer-based resin.

When the resin composition contains the other thermoplastic resin, the content thereof is preferably 20% by mass or less, more preferably 15% by mass or less, and still more preferably 10% by mass or less, based on the total mass of the resin composition. When the content of the other thermoplastic resin in the resin composition exceeds 20% by mass, transparency, impact resistance, and adhesion to a base material such as glass tend to be deteriorated easily.

The resin composition of the present invention may further contain additives such as a plasticizer, an antioxidant, an ultraviolet absorber, an adhesive improving agent, an anti-blocking agent, a silane coupling agent, a pigment, a dye, a heat-shielding material and a functional inorganic compound, if necessary. Further, if necessary, a plasticizer or various additives may be extracted or washed, so that once the content of these plasticizers and additives is reduced, a plasticizer, various additives, and the like may be added again.

When the resin composition contains the additive, the content thereof is preferably 20% by mass or less, or 15% by mass or less, or 10% by mass or less, or 5% by mass or less, based on the total mass of the resin composition. When the content of the various additives is too high, problems such as not sufficiently obtaining self-supporting property (heat resistance) under high temperature conditions and bleeding when used for a long period of time as an interlayer film for laminated glass tend to occur.

In particular, since the plasticizer has a high effect of lowering the self-supporting property (heat resistance) under high temperature conditions from its nature, in one embodiment the resin composition is substantially free of plasticizer, for example, its content is 1% by mass or less (including 0% by mass), or 0.5% by mass or less (including 0% by mass), or 0.1% by mass or less (including 0% by mass), based on the total mass of the resin composition.

Although there is no particular limitation on the plasticizer used, for example, triethylene glycol-di-2-ethylhexanoate, tetraethylene glycol-di-2-ethylhexanoate, di-(2-butoxyethyl)-adipic acid ester (DBEA), di-(2-butoxyethyl)-sebacic acid ester (DBES), di-(2-butoxyethyl)-glutaric acid ester, di-(2-butoxyethoxyethyl)-adipic acid ester (DBEEA), di-(2-butoxyethoxyethyl)-sebacic acid ester (DBEES) di-(2-butoxyethyl)-azelaic acid ester, di-(2-butoxyethyl)-glutaric acid ester, di-(2-hexoxyethyl)-adipic acid ester, di-(2-hexoxyethyl)-azelaic acid ester, Mention may be made of di-(2-hexoxyethyl)-glutaric acid ester, di-(2-hexoxyethoxyethyl)-adipic acid ester, di-(2-hexoxyethoxyethyl)-sebacic acid ester, di-(2-hexoxyethoxyethyl)-azelaic acid ester, di-(2-hexoxyethoxyethyl)-glutaric acid ester, di-(2-butoxyethyl)-phthalic acid ester and/or di-(2-butoxyethoxyethyl)-phthalic acid ester and the like. Among these, a plasticizer having a sum of the number of carbon atoms and the number of oxygen constituting a molecule of 28 or more is preferred. Examples thereof include triethylene glycol-di-2-ethylhexanoate, tetraethylene glycol-di-2-ethylhexanoate, di-(2-butoxyethoxyethyl)-adipic acid ester, and di-(2-butoxyethoxyethyl)-sebacic acid ester. The above plasticizer may be used a single, or 2 or more of them may be used in combination.

Further, the modified vinyl acetal resin of the present invention may contain an antioxidant. Examples of the antioxidant used include a phenol-based antioxidant, a phosphorus-based antioxidant, and a sulfur-based antioxidant, and among these, a phenol-based antioxidant is preferred, and an alkyl-substituted phenol-based antioxidant is particularly preferred.

Examples of the phenolic antioxidant include acrylate-based compounds such as 2-t-butyl-6-(3-t-butyl-2-hydroxy-5-methylbenzyl)-4-methylphenylacrylate or 2,4-di-t-amyl-6-(1-(3,5-di-t-amyl-2-hydroxyphenyl)ethyl)phenylacrylate, 2,6-di-t-butyl-4-ethylphenol,octadecyl-3-(3,5-di-t-butyl-4-hydroxyphenyl)propionate, 2,T-methylene-bis(4-methyl-6-t-butylphenol), 4,4′-butylidene-bis(6-t-butyl-m-cresol), 4,4′-thiobis(3-methyl-6-t-butylphenol),bis(3-cyclohexyl-2-hydroxy-5-methylphenyl)methane, 3,9-bis(3-(3-t-butyl-4-hydroxy-5-methylphenyl)propionyloxy)-1,1-dimethylethyl)-2,4,8,10-tetraoxaspiro[5,5]undecane, 1,1,3-tris(2-methyl-4-hydroxy-5-t-butylphenyl)butane,alkyl-substituted phenolic compounds such as 1,3,5-trimethyl-2,4,6-tris(3,5-di-t-butyl-4-hydroxybenzyl)benzene, tetrakis(methylene-3′,5′-di-t-butyl-4′-hydroxyphenyl)propionate) methane or triethylene glycol bis(3-(3-t-butyl-4-hydroxy-5-methylphenyl)propionate,6-(4-hydroxy-3,5-di-t-butylanilino)-2,4-bis-octylthio-1,3,5-triazine, Examples thereof include triazine group-containing phenolic compounds such as 6-(4-hydroxy-3,5-dimethylanilino)-2,4-bis-octylthio-1,3,5-triazine, 6-(4-hydroxy-3-methyl-5-t-butylanilino)-2,4-bis-octylthio-1,3,5-triazine or 2-octylthio-4,6-bis-(3,5-di-t-butyl-4-oxyanilino)-1,3,5-triazine.

As the phosphorus-based antioxidant, for example, triphenylphosphite, diphenylisodecylphosphite, phenyldiisodecylphosphite, tris(nonylphenyl)phosphite, tris(2-t-butyl-4-methylphenyl)phosphite, 2,2-methylenebis(4,6-di-t-butylphenyl)octylphosphite, 9,10-dihydro-9-oxa-10-phosphaphenanthrene-10-oxide,monophosphite-based compounds such as 10-(3,5-di-t-butyl-4-hydroxybenzyl)-9,10-dihydro-9-oxa-10-phosphaphenanthrene-10-oxide or 10-decyloxy-9,10-oxa-10-phosphaphenanthrene, 4,4′-butylidene-bis(3-methyl-6-t-butylphenyl-di-tridecylphosphite), 4,4′-isopropylidene-bis(phenyl-di-alkyl(C12 to C15) phosphite), 4,4′-isopropylidene-bis(diphenylmonoalkyl(C12 to C15) phosphite),1,1,3-Tris(2-methyl-4-di-tridecylphosphite-5-t-butylphenyl)butane or diphosphyte-based compounds such as tetrakis(2,4-di-t-butylphenyl)-4,4′-biphenylene phosphite, and the like. Among these, monophosphite-based compounds are preferred.

Examples of the sulfur-based antioxidant include dilauryl 3,3′-thiodipropionate, distearyl 3,3′-thiodipropionate, lauryl stearyl 3,3′-thiodipropionate, pentaerythritol-tetrakis-(β-lauryl-thiopropionate), 3,9-bis(2-dodecylthioethyl)-2,4,8,10-tetraoxaspiro[5,5]undecane, and the like.

An amount of the antioxidant to be blended is preferably 0.001 to 5 parts by mass, more preferably 0.01 to 1 parts by mass, per 100 parts by mass of the modified vinyl acetal resin. These antioxidants may be added in producing the modified vinyl acetal resin of the present invention. As another addition method, it may be added to the modified vinyl acetal resin when the plate-like molded body of the present invention is molded.

Further, the modified vinyl acetal resin of the present invention may contain an ultraviolet absorber. UV inhibitors used are 2-(5-methyl-2-hydroxyphenyl)benzotriazole, 2-[2-hydroxy-3,5-bis(α,α′dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, and 2-(3,5-di-t-butyl-5-methyl-2-hydroxyphenyl)-5-chlorobenzotriazole benzotriazole-based UV absorbers such as 2-(3,5-di-t-amyl-2-hydroxyphenyl)benzotriazole or 2-(2′-hydroxy-octylphenyl)benzotriazole, 2,2,6,6-tetramethyl-4-piperidylbenzoate, bis(2,2,6,6-tetramethyl-4-piperidyl)cebacate, Hinderamine-based UV absorbers such as bis(1,2,6,6-pentamethyl-4-piperidyl)-2-(3,5-di-t-butyl-4-hydroxybenzyl)-2-butylmalonate or 4-(3-(3,5-di-t-butyl-4-hydroxyphenyl)propionyloxy)-1-(2-(3-(3,5-di-t-butyl-4-hydroxyphenyl)ethyl)-2,2,6,6-tetramethylpyridine Examples include 2,4-di-t-butylphenyl-3,5-di-t-butyl-4-hydroxybenzoate or benzoate-based UV absorbers such as hexadecyl-3,5-di-t-butyl-4-hydroxybenzoate. The amount of these ultraviolet absorbers to be added is preferably 10 to 50000 ppm based on the mass based on the modified vinyl acetal resin, and more preferably in the range of 100 to 10000 ppm. In addition, 2 or more of these ultraviolet absorbers may be used in combination. These ultraviolet absorbers may be added in producing the modified vinyl acetal resin of the present invention. As another addition method, it may be added to the modified vinyl acetal resin when the plate-like molded body of the present invention is molded.

Further, the modified vinyl acetal resin of the present invention may contain an adhesive improving agent. As the adhesive improving agent used, for example, those disclosed in WO03/033583A1 can be used, and an alkali metal salt and/or an alkaline earth metal salt of an organic acid is preferably used, and among them, potassium acetate and/or magnesium acetate and the like are preferred. Further, other additives such as silane coupling may be added. The optimum amount of the adhesion improver to be added varies depending on the additive used, and also depending on where the resulting module or laminated glass is used, but it is preferable to adjust the adhesive force of the obtained sheet to be generally 3 to 10 in the pummel test (described in WO03/033583A1 and the like), and it is preferable to adjust the amount to 3 to 6 when a high penetration resistance is required, and 7 to 10 when a high glass scattering prevention property is required. When high glass scattering prevention property is required, it is also a useful method to not add an adhesive improving agent.

Further, the modified vinyl acetal resin of the present invention may contain a silane coupling agent. Examples of the adhesive improving agent used include 3-glycidoxypropyltrimethoxysilane, 3-glycidoxypropyldiethoxysilane, N-(2-aminoethyl)-3-aminopropyltrimethoxysilane, N-(2-aminoethyl)-3-aminopropyldiethoxysilane, and N-(2-amino ethyl)-3-aminopropyldiethoxysilane.

These silane coupling agents may be used alone or in combination of 2 or more thereof. The amount of the silane coupling agent to be blended is preferably 0.001 to 5 parts by mass, more preferably 0.01 to 1 parts by mass, per 100 parts by mass of the modified vinyl acetal resin. These silane coupling agents may be added in producing the modified vinyl acetal resin of the present invention. As another addition method, it may be added to the modified vinyl acetal resin when the plate-like molded body of the present invention is molded.

When a laminated glass is prepared by incorporating a heat-shielding fine particle or a heat-shielding compound as the heat-shielding material into the interlayer of the present invention to give a heat-shielding function to the laminate, transmittance of the sun's infra-red radiation can be regulated.

Suitable heat-shielding fine particles are disclosed, for example, in US2017/0320297A1.

Specific examples of the heat-shielding fine particle include a metal-doped indium oxide, such as tin-doped indium oxide (ITO), a metal-doped tin oxide, such as antimony-doped tin oxide (ATO), a metal-doped zinc oxide, such as aluminum-doped zinc oxide (AZO), a metal element composite tungsten oxide represented by a general formula: MₘWOₙ (M represents a metal element; m is about 0.01 or more and about 1.0 or less; and n is about 2.2 or more and about 3.0 or less), zinc antimonate (ZnSb₂O₅), lanthanum hexaboride, and the like. Of those, ITO, ATO, and a metal element composite tungsten oxide are preferred, and a metal element composite tungsten oxide is more preferred. Examples of the metal element represented by M in the metal element composite tungsten oxide include Cs, Tl, Rb, Na, K, and the like, and in particular, Cs is preferred. From the viewpoint of heat shielding properties, m is preferably about 0.2 or more, or about 0.3 or more, and it is preferably about 0.5 or less, or about 0.4 or less.

From the viewpoint of transparency of the ultimate laminate, an average particle diameter of the heat shielding fine particle is preferably about 100 nm or less, or about 50 nm or less. It is to be noted that the average particle diameter of the heat-shielding particle as referred to herein means one measured by a laser diffraction instrument.

In the final resin composition, a content of the heat shielding fine particle is preferably about 0.01% by weight or more, or about 0.05% by weight or more, or about 0.1% by weight or more, or about 0.2% by weight or more relative to the weight of the resin. In addition, the content of the heat shielding fine particle is preferably about 5% by weight or less, or about 3% by weight or less.

Examples of the heat-shielding compound include phthalocyanine compounds, naphthalocyanine compounds, and the like. From the viewpoint of further improving the heat shielding properties, it is preferred that the heat shielding compound contains a metal. Examples of the metal include Na, K, Li, Cu, Zn, Fe, Co, Ni, Ru, Rh, Pd, Pt, Mn, Sn, V, Ca, Al, and the like, with Ni being especially preferred.

A content of the heat shielding compound is preferably about 0.001% by weight or more, or about 0.005% by weight or more, or about 0.01% by weight or more, based on the weight of the resin. In addition, the content of the heat shielding compound is preferably about 1% by weight or less, or about 0.5% by weight or less.

Colored interlayers can be formed as generally known in the art.

For example, one or more pigments can be added to the resin composition as generally disclosed in US2008/0302461A1.

Blends of one or more of the inorganic particles with one or more dyes can also be used.

In some cases, it may be desired to form a translucent interlayer to produce laminates, for example, having the aesthetic qualities of etched or sandblasted glass, such as disclosed in U.S. Pat. No. 7,261,943B2, or having a translucent white appearance, such as disclosed in US2013/0225746A1.

Decorative glass laminates bearing an image can also be prepared as described, for example, in U.S. Pat. No. 7,232,213B2.

### Interlayer (Sheet or Film)

The storage modulus (E′) of the modified vinyl acetal resin of the present invention or a plate-like molded article comprising the same under the conditions of a measurement temperature of 50° C. and a frequency of 1 Hz is preferably 20 to 1000 MPa, more preferably 30 to 900 MPa, and still more preferably 40 to 800 MPa. When the storage modulus (E ‘) is within the above range, the self-supporting property is further improved. In the present invention, the storage modulus (E’) was measured by the method described in the Examples.

There is no particular limitation on the method of manufacturing the interlayer body, and a known method is used. Specifically, the resin composition may be formed into a sheet or film by extrusion molding, press molding, blow molding, injection molding, solution casting, or the like. In particular, a method is preferred in which a resin composition and an additive are supplied to an extruder, kneaded, melted, and taken out of a die to form a sheet or film. The resin temperature at the time of extrusion is typically from about 170° C., or from about 180° C., or form about 190° C., to about 250° C., or to about 240° C., or to about 230° C. If the resin temperature becomes too high, the modified vinyl acetal resin undergoes decomposition, the content of volatile substances increases, and the color increases. On the contrary, if the temperature is too low, extrusion becomes very difficult and the content of volatiles will also increase. In order to efficiently remove volatile substances, it is preferable to remove volatile substances by decompression from the vent port of the extruder.

It is preferable for the interlayers of the present invention to provide irregularities on the surface in order to prevent the interlayers from adhering to each other during production and storage, and to enhance the degassing property in the laminating step as discussed below. In addition, it is preferred that a concave and convex structure, such as a melt fracture and/or an embossing, is formed on the surface of the interlayer of the present invention by a conventionally known method. A shape of the melt fracture or embossing is not particularly limited, and those which are conventionally known can be adopted.

Preferably, such a structure is provided on at least one surface (and more preferably both surfaces) of the interlayer for a laminated glass.

Examples of a method for shaping the surface of the interlayer for a laminated glass include a conventionally known embossing roll method, a profile extrusion method, and an extrusion lip embossing method utilizing melt fracture. Among these, an embossing roll method is preferred for stably obtaining the interlayer for a laminated glass having uniform and fine concave and convex portions formed thereon.

An embossing roll to be used in the embossing roll method can be produced by, for example, using an engraving mill (mother mill) having a desired concave-convex pattern and transferring the concave-convex pattern to the surface of a metal roll. Further, an embossing roll can also be produced using laser etching. Further, after forming a fine concave-convex pattern on the surface of a metal roll as described above, the surface with the fine concave-convex pattern is subjected to a blast treatment using an abrasive material such as aluminum oxide, silicon oxide, or glass beads, whereby a finer concave-convex pattern can also be formed.

Further, the embossing roll to be used in the embossing roll method is preferably subjected to a release treatment. In the case where an embossing roll which is not subjected to a release treatment is used, it becomes difficult to release the interlayer for a laminated glass from the embossing roll. Examples of a method for the release treatment include known methods such as a silicone treatment, a Teflon (registered trademark) treatment, and a plasma treatment.

The depth of the concave portion and/or the height of the convex portion (hereinafter sometimes referred to as “the height of the embossed portion”) of the surface of the interlayer for a laminated glass shaped by an embossing roll method or the like are/is preferably about 5 μm or more, or about 10 μm or more, or about 20 μm or more. When the height of the embossed portion is about 5 μm or more, in the case where a laminated glass is produced, an air bubble present at an interface between the interlayer for a laminated glass and a glass is less likely to remain, and thus, the appearance of the laminated glass tends to be improved.

The height of the embossed portion is preferably about 150 μm or less, or about 100 μm or less, or about 80 μm or less. When the height of the embossed portion is about 150 μm or less, in the case where a laminated glass is produced, the adhesiveness between the interlayer for a laminated glass and a glass becomes favorable, and thus, the appearance of the laminated glass tends to be improved.

In the invention, the height of the embossed portion refers to a maximum height roughness (Rz) defined in JIS B 0601 (2001). The height of the embossed portion can be measured by, for example, utilizing the confocal principle of a laser microscope or the like. Incidentally, the height of the embossed portion, that is, the depth of the concave portion or the height of the convex portion may vary within a range that does not depart from the gist of the invention.

Examples of the form of the shape imparted by an embossing roll method or the like include a lattice, an oblique lattice, an oblique ellipse, an ellipse, an oblique groove, and a groove. Among these, the form is preferably an oblique lattice, an oblique groove, or the like from the viewpoint that an air bubble more favorably escapes. The inclination angle is preferably from 10° to 80° with respect to the film flow direction (MD direction).

The shaping by an embossing roll method or the like may be performed on one surface of the interlayer for a laminated glass, or may be performed on both surfaces, but is more preferably performed on both surfaces. Further, the shaping pattern may be a regular pattern or an irregular pattern such as a random matte pattern, or a pattern such as disclosed in U.S. Pat. No. 7,351,468B2.

The thickness of the interlayer of the present invention is not particularly limited, but is preferably from about 0.10 mm, or from about 0.40 mm, or from about 0.70 mm, to about 3.0 mm, or to about 2.8 mm, or to about 2.6 mm. When the interlayer is too thin, it tends to be difficult to satisfy the penetration resistance performance of the laminated glass, and when the interlayer is too thick, the cost of the sheet itself is high, and is not preferable because the cycle time of the lamination process tends to be long. The interlayer may be a single layer, or the thickness can be adjusted to a desired thickness by using two or more layers.

The penetration resistance of the film or sheet of the present invention preferably has a penetration energy of 11 J or more, more preferably 13 J or more, and still more preferably 15J or more in a falling weight type impact test described later. When the penetration resistance of the plate-like molded article is too low, the penetration resistance of the laminated glass using the plate-like molded article as an intermediate film cannot obtain a sufficient value, and it tends to be difficult to use.

The film or sheet of the present invention is useful as an interlayer for laminated glass. The interlayer film for laminated glass is particularly preferred as an interlayer film for laminated glass for structural materials from the viewpoint of excellent adhesion to a substrate such as glass, transparency, and self-supporting property. Further, it is not limited to an intermediate film of laminated glass for structural material, but is also suitable as an intermediate film for laminated glass in various applications such as a mobile body such as an automobile, a building, a solar cell, and the like, but is not limited to these applications.

### Laminated Glass

A laminated glass can be produced by inserting and laminating an interlayer of the present invention between 2 or more sheets of glass made of inorganic glass or organic glass. There is no particular limitation on the glass to be laminated with the interlayer film for laminated glass of the present invention. Although there is no particular limitation on the thickness of the glass, it is preferably from about 1 mm, or from about 2 mm, to about 10 mm, or to about to 6 mm.

The glass used can be inorganic or organic in nature. Inorganic glass includes not only window glass, plate glass, silicate glass, sheet glass, low iron glass, tempered glass, tempered CeO-free glass, and float glass, but also to include colored glass, specialty glass (such as those include ingredients to control, e.g., solar heating), coated glass (such as those sputtered with metals (e.g., silver or indium tin oxide) for solar control purposes), E-glass, Toroglass, Solex.RTM glass (PPG Industries, Pittsburgh, Pa.). Such specialty glasses are disclosed in, e.g., U.S. Pat. Nos. 4,615,989, 5,173,212, 5,264,286, 6,150,028, 6,340,646B1, U.S. Pat. No. 6,461,736B1 and U.S. Pat. No. 6,468,934B2. The type of glass to be selected for a particular laminate depends on the intended use.

Organic glass can include, but is not limited to, polycarbonates, acrylics, polyacrylates, cyclic polyolefins (e.g., ethylene norbornene polymers), polystyrenes (preferably metallocene-catalyzed polystyrenes), polyamides, polyesters, fluoropolymers and the like and combinations of two or more thereof.

The interlayer used in the laminated glass of the present invention may be composed only of a layer (x) containing the above-mentioned modified resin composition, and may be a multilayer film containing at least 2 layers (x). The multilayer film is not particularly limited, and examples thereof include a 2 layer film in which a layer (x) and another layer are laminated, and a 3 layer film in which another layer is disposed between the 2 layers (x)

Examples of the other layer include a layer containing a known resin. As the resin, for example, polyethylene, polypropylene, polyvinyl chloride, polystyrene, polyurethane, polytetrafluoroethylene, acrylic resin, polyamide, polyacetal, polycarbonate, polyester, polyethylene terephthalate, polybutylene terephthalate, cyclic polyolefin, polyphenylene sulfide, polytetrafluoroethylene, polysulfone, polyether sulfone, polyarylate, liquid crystal polymer, polyimide, and the like can be used. Further, other layers may also contain additives such as a plasticizer, an antioxidant, an ultraviolet absorber, a light stabilizer, an anti-blocking agent, a pigment, a dye, a heat shielding material (e.g., an inorganic heat shielding material or an organic heat shielding material having infrared absorbing ability), and a functional inorganic compound, if necessary.

The laminating method for obtaining the laminated glass described above can take a known method, and examples thereof include a method using a vacuum laminator apparatus, a method using a vacuum bag, a method using a vacuum ring, and a method using a nip roll. Further, after temporary bonding, the method of throwing into the autoclaving step can also be performed additionally.

When a nip roll is used, for example, a method in which a first temporary adhesion is performed at a temperature lower than or equal to a flow start temperature of a modified vinyl acetal resin, and then a temporary adhesion is further performed under a condition close to a flow start temperature. Specifically, there may be mentioned, for example, a method in which the mixture is heated to from about 30° C. to about 70° C. by an infrared heater or the like, then degassed by a roll, and further heated to from about 50° C. to about 120° C., and then crimped by a roll to be bonded or temporarily bonded.

The autoclaving step, which is additionally performed after temporary bonding, is carried out for about 2 hours at a temperature of from about 130° C. to about 145° C., for example, under a pressure of from about 1 MPa to about 5 MPa, depending on the thickness and configuration of the module and the laminated glass.

It is preferable that the laminated glass of the present invention is excellent in transparency. Haze is the percentage of luminous flux that is scattered at a specified angle. For example, the haze when the laminated glass is gradually cooled under conditions described later is desirably 2% or less, or 1.6% or less, or 1.2% or less. Haze can be measured using a haze meter in accordance with ISO 14782.

It is preferable that the laminated glass of the present invention is excellent in adhesion to glass. For example, the peel stress in the compressive shear strength test performed by the method described later is desirably from 20 MPa, or from 22 MPa, or from 24 MPa, to 40 MPa, or to 38 MPa, or to 36 MPa. If the peeling stress is too low, adhesion between the glass and interlayer is insufficient and there is a tendency that the glass is scattered at the time of glass breakage. If the peel stress is too high, the adhesive strength between the glass and interlayer is too strong and penetration resistance at the time of glass breakage may be reduced.

In the case where the laminated glass of the present invention includes a heat-shielding material, a transmittance at a wavelength of 1,500 nm is preferably about 50% or less, or about 20% or less. When the transmittance at a wavelength of 1,500 nm is about 50% or less, there is a tendency that a shield factor of infrared rays is high, so that heat shielding performance of the laminated glass is improved.

Heat/Shielding and solar resistance can also be provide by the use of low-E glass and/or IR reflective technology such as generally known to those of ordinary skill in the relevant art, for example, as disclosed in U.S. Pat. No. 7,291,398B2.

### End Uses

Since the laminated glass of the present invention has excellent transparency, impact resistance, formability, heat resistance and creep behavior, it can be suitably and reliably used in higher-temperature applications where other conventional materials may have limited reliability. Since the laminated glass of the present invention has excellent transparency, impact resistance, heat resistance and formability, automotive windshields, automotive side glass, automotive sunroofs, automotive rear glass, head-up display glass, facades, laminates for the outer wall and roof, panels, doors, windows, walls, sunroofs, sound insulation walls, display windows, balconies, construction materials such as handrail walls, partition glass members of meeting rooms, solar panels, etc. can be suitably used.

In particular, the laminates of the present invention find application in overhead glazings, spandrels, fins and bolted glazing applications, which are particularly high-temperature sensitive end uses with typical interlayer materials.

Overhead glazings are used in a variety of situations. For example, conventional overhead glazing systems for walkways, canopies and the like generally include a plurality of horizontal framing members or purlins and vertical framing members or rafters interconnected to form a structural framing unit and a top mounted pressure plate for retaining glazing panels in place against the framing unit. U.S. Pat. No. 8,356,454B2. Overhead glazing is particularly susceptible to interlayer creep causing failure of the glazing and, in a worst case, loss of adhesion of the glass panel and increased risk of falling glass. The risk of failure, particularly at elevated temperatures, can be reduced by using the low-creep interlayers and laminated glass of the present invention.

In buildings of more than one story the spandrel is the area between the sill of a window and the head of the window below it. Spandrel panels are used, for the most part, to conceal interior portions of a building that would not necessarily be aesthetically pleasing if viewed from the exterior of the building. Examples of such interior portions would be building frame members, heating and air conditioning ducts, tubing or plumbing, and electrical cables or conduits. In addition to concealing interior portions of the building, a spandrel panel will typically aesthetically complement or harmonise with the windows of the glazing system and other attributes of the building. Details about laminated spandrel panels and their use are in general well known to those of ordinary skill in the relevant art, for example, as exemplified by EP2517877A2 and other publications cited therein. As with overhead glazing, failure of spandrel panels can occur due to interlayer creep, especially at elevated temperatures, which risk can be reduced by using the low-creep interlayers and laminated glass of the present invention.

Glass fins are used to support glazed facades and enhance their rigidity. They can also act as support for glazed roofs. Because of their necessity for structural integrity, any loss of integrity of the laminate due to creep can result in falling glass or catastrophic failure. The risk of failure can be reduced by using the low-creep interlayers and laminated glass of the present invention.

Bolted glass systems (also called direct point attachment glazing) are also in general known to those of ordinary skill in the relevant art, for example, as exemplified by US2006/0005482A1. In conventional bolted systems, low-creep inserts and bushings between the bolt and interlayer are usually required to ensure that the bolt tension is maintained; otherwise, the bolt loosens with time due to interlayer creep causing potential structural problems, particularly in higher temperature applications. The use of such bushings increases the cost and complexity of laminate fabrication, which can be avoided in part or in whole by use of the lower-creep interlayers and laminates of the present invention.

### EXAMPLES

Hereinafter, the present invention will be described in further detail by way of Examples, but the present invention is not limited to these Examples.

### Determination of Ethylene Unit, Vinyl Alcohol Unit, Acetal Unit, Degree of Acetalization

The ethylene vinyl alcohol copolymer prior to the acetalization reaction was dissolved in DMSO at 120° C., cooled at room temperature, and then N,N-dimethyl-4-aminopyridine and acetic anhydride were added thereto, followed by stirring reaction for 1 hours, followed by precipitation with ion-exchanged water and acetone, and clean and drying to obtain an ethylene vinyl acetate copolymer. The obtained ethylene vinyl acetate copolymer was dissolved in DMSO-d₆, and the molar ratio (n) of the ethylene unit of the ethylene vinyl alcohol copolymer was calculated from the intensity ratio of the methine proton (peak of 1.1 to 1.9 ppm) derived from the ethylene unit and the vinyl acetate unit, and the terminal methyl proton (peak of 2.0 ppm) derived from the vinyl acetate unit from the spectrum obtained by measuring the ethylene vinyl acetate copolymer by a proton NMR measuring device of 400 MHz at 256 times of integration number. Here, since the ethylene unit is not affected by the acetalization reaction, the molar ratio (n) of the ethylene unit of the ethylene vinyl alcohol copolymer before the acetalization reaction is treated as equal to the molar ratio (n) of the ethylene unit of the modified vinyl acetal resin obtained after the acetalization reaction.

The molar proportions (1) of vinyl alcohol units, molar proportions (m) of vinyl acetate units, and molar proportions (k) of acetalized vinyl alcohol units to all monomer units making up the modified vinyl acetal resin were calculated from spectra obtained by dissolving the modified vinyl acetal resin in DMSO-d₆ and measuring with a 400-MHz proton NMR spectrometer at 256 cumulative times, using the intensity ratio of ethylene units, vinyl alcohol units, and methyl protons derived from vinyl ester units (peaks of 1.0-1.8 ppm), and terminal methyl protons derived from acetal units (peaks of 0.8-1.0 ppm), and the molar proportions (n) of ethylene vinyl alcohol units copolymer.

The degree of acetalization (DA1) of the modified vinyl acetal resin was determined by using the molar ratio of the vinyl alcohol unit (1), the molar ratio of the vinyl acetate unit (m), and the molar ratio of the acetalized vinyl alcohol unit (k), as determined above.

### Evaluation of Stiffness Under High-Temperature Environment

The melt-kneaded product of the resin composition obtained by the method described later was compression-molded at a pressure of 50 kgf/cm² for 5 minutes at 200° C., to obtain a sheet having a thickness of 0.8 mm. A test piece of vertical 40 mm×horizontal 5 mm was cut out from the sheet, and the storage elastic modulus (E′) was measured using a dynamic viscoelasticity measuring device manufactured by UBM Corporation, the measurement temperature 50° C., under the condition of a frequency 1 Hz. The obtained value is an indicator of the stiffness of the interlayer film for laminated glass under a high-temperature environment.

### Evaluation of Penetration Resistance

The melt-kneaded product of the resin composition obtained by the method described later was compression-molded at a pressure of 50 kgf/cm² for 5 minutes at 200° C., to obtain a sheet having a thickness of 0.8 mm. A test piece of vertical 60 mm×horizontal 60 mm was cut out from the sheet, and a fall weight type shock testing machine (CEAST9350 manufactured by Instron Co., Ltd.) was used to perform tests under the conditions of measurement temperature of 23° C., a load of 2 kg, and a collision speed 9m per sec in accordance with ASTM D3763. Penetration energy was calculated from the area of the SS curve from the moment when the striker edge came into contact with the test piece (sensing the test force) to the moment when it permeated (the test force returned to zero) to the pass-through (returning the test force to zero).

### Evaluation of Film-Forming Property

A sheet in a resin composition obtained by a method described later having a thickness of 0.8 mm and a width of 50 cm was produced by forming a film under a condition of a barrel temperature of 200° C. using a 40 mm diameter full-flight 1 axis extruder and a 60 cm width coated hanger die. The case where the film formation stability at this time was observed and continuous film formation was possible without any problem and a good appearance sheet was obtained was evaluated as A, and a case where a problem such as breakage and loosening of the sheet occurred and a good appearance sheet could not be obtained was evaluated as B.

### Evaluation of Glass Adhesion

The melt-kneaded product of the resin composition obtained by the method described later was compression-molded at a pressure of 50 kgf/cm² for 5 minutes at 210° C., to obtain a sheet having a thickness of 0.8 mm. The obtained sheet was sandwiched between 2 sheets of float glass having a thickness of 2.7 mm, and a vacuum laminator (1522N manufactured by Nisshinbo Mechatronics Co., Ltd.) was used to reduce the pressure for 1 minute at 100° C., and the vacuum laminator was pressed at 30 kPa for 5 minutes while holding the reduced pressure degree and the temperature to obtain an intermediate laminate. The resulting intermediate laminate was charged into an autoclave and treated at 140° C. and a pressure of 1.2 MPa for 30 minutes to obtain a final laminated glass. The resulting laminated glass was cut to a size of 25 mm×25 mm to obtain test samples. The obtained test samples were evaluated by the compressive shear strength test (Compression shear strength test) described in WO1999/058334A2. The maximum shear stress when the laminated glass was peeled off was used as an indicator of glass adhesion.

### Evaluation of Transparency

After heating the laminated glass obtained by the above method to 140° C., and gradually cooling to 23° C. at a rate of 0.1° C./min (slow cooling), the haze of the laminated glass was measured. Haze was measured using a haze meter (HZ-1, Suga Test Instruments Co., Ltd.) in accordance with ISO 14782.

### Example 1—Synthesis of Modified Vinyl Acetal Resin

100 parts by weight of chips of ethylene vinyl alcohol copolymer synthesized according to the process described in Japanese Patent Application Laid-Open No. 2016-28139, containing 44 mol % of ethylene units, 99% of saponification degree, and an MFR of 5.5 g/10 minutes, was dispersed in 315 parts by weight of 1-propanol, then the temperature of the solution was raised to 60° C. with agitation, then 40 parts by weight of 1 M hydrochloric acid was added thereto, then 16.7 parts by weight of n-butyraldehyde was added thereto to disperse the solution, then the acetalization reaction was carried out while maintaining the temperature at 60° C. As the reaction proceeded, the chip dissolved and became a homogeneous solution. At the time of holding for 36 hours from the start of the reaction, 6.4 parts by weight of sodium hydrogen carbonate was added to stop the reaction. After adding 500 parts by weight of 1-propanol to the reaction solution to make it uniform, the resulting mixture was added dropwise to 2000 parts by weight of water to precipitate a resin. Thereafter, the operation of filtration and washing with water was repeated 3 times, and vacuum drying was carried out at 60° C. for 8 hours to obtain a modified vinyl acetal resin. The obtained modified vinyl acetal resin had an ethylene unit of 44 mol % and an acetalization degree of 31 mol %.

The modified vinyl acetal resin obtained above was melt-kneaded for 3 minutes at a chamber temperature of 200° C. and a rotational speed of 100 rpm using a lab plastid mill (device name “4M150”, manufactured by Toyo Seiki Co., Ltd.), and the contents of the chamber were taken out and cooled to obtain a melt-kneaded product. Various physical properties were evaluated using the obtained melt-kneaded product. The results are given in Table 1.

### Examples 2 to 6

Each modified vinyl acetal resin was obtained in the same manner as in Example 1, except that the ethylene unit of the ethylene vinyl alcohol copolymer used, the amount of MFR and n-butylaldehyde added, and the reaction time were changed as shown in Table 1, and the mixture was melt-kneaded in the same manner as in Example 1 to obtain a melt-kneaded product. Various physical properties were evaluated using the obtained melt-kneaded product. The results are given in Table 1.

### Example 7

A melt-kneaded product was obtained in the same manner as in Example 1, except that each modified vinyl acetal resin was obtained in the same manner as in Example 2, and 8 parts by weight of triethyleneglycol-di-2-ethylhexanoate was added as a plasticizer per 100 parts by weight of the modified vinyl acetal resin. Various physical properties were evaluated using the obtained melt-kneaded product. The results are given in Table 1.

TABLE 1

| | | Examples | | | | | | |
|---|---|---|---|---|---|---|---|---|
| | | 1 | 2 | 3 | 4 | 5 | 6 | 7 |
| Ethylene | Ethylene unit (mol %). | 44 | 44 | 44 | 48 | 38 | 27 | 44 |
| vinyl | Vinyl alcohol units (mol %) | 56 | 56 | 56 | 52 | 62 | 73 | 56 |
| alcohol | MFR(g/10 min) | 5.5 | 5.5 | 1.7 | 6.4 | 1.7 | 1.6 | 5.5 |
| copolymer | | | | | | | | |
| Reaction | Ethylene vinyl alcohol copolymer | 100 | 100 | 100 | 100 | 100 | 100 | 100 |
| conditions | (parts by weight) | | | | | | | |
| | 1M hydrochloric acid (parts by | 40 | 40 | 40 | 40 | 40 | 40 | 40 |
| | weight) | | | | | | | |
| | n-butyraldehyde (parts by weight) | 16.7 | 11.9 | 18.9 | 6.5 | 20.3 | 15.4 | 12.4 |
| | Sodium carbonate (parts by weight) | 6.4 | 6.4 | 6.4 | 6.4 | 6.4 | 6.4 | 6.4 |
| | Reaction time (hours) | 36 | 45 | 36 | 36 | 36 | 36 | 40 |
| Modified | Degree of acetalization (mol %/PVA | 31 | 22 | 35 | 13 | 34 | 22 | 23 |
| vinyl | unit) | | | | | | | |
| acetal | Ethylene unit (mol %). | 44 | 44 | 44 | 48 | 38 | 27 | 44 |
| resin | Vinyl alcohol units (mol %) | 39 | 44 | 36 | 45 | 41 | 57 | 43 |
| | Acetal unit (mol %). | 17 | 12 | 20 | 7 | 21 | 16 | 13 |
| | MFR(g/10 min) | 10 | 8 | 4 | 6 | 3 | 27 | 8 |
| Resin | Plasticizer (phr) | None | None | None | None | None | None | 8 |
| composition | MFR(g/10 min) | 10 | 8 | 4 | 6 | 3 | 27 | 26 |
| Sheet-like | Penetration energy (J) | 15 | 16 | 15 | 16 | 13 | 11 | 16 |
| composite | Storage modulus (MPa)@50° C. | 130 | 280 | 85 | 110 | 490 | 950 | 38 |
| | Film formability | A | A | A | A | A | A | A |
| Laminated | Haze (%) | 1.2 | 1.5 | 1.2 | 1.1 | 1.8 | 1.6 | 1.5 |
| glass | Maximum shearing stress (MPa/m²) | 32 | 35 | 31 | 33 | 33 | 33 | 35 |

### Comparative Examples 1 to 4

Each modified vinyl acetal resin was obtained in the same manner as in Example 1, except that the ethylene unit of the ethylene vinyl alcohol copolymer used, the amount of MFR and n-butylaldehyde added, and the reaction time were changed as shown in Table 2, and a melt-kneaded product was obtained in the same manner as in Example 1 Various physical properties were evaluated using the obtained melt-kneaded product. Table 2 shows the results.

### Comparative Example 5

1700 parts by weight of a 7.5% aqueous solution of vinyl alcohol resin having a saponification degree of 99% and 74.6 parts by weight of butyraldehyde and 0.13 parts by weight of 2,6-di-t-butyl-4-methylphenol were charged, and the whole was cooled to 14° C. To this was added 160.1 parts by weight of hydrochloric acid having a concentration of 20% by mass to initiate an acetalization reaction. After 10 minutes after the addition of hydrochloric acid was completed, the temperature was raised to 65° C. over 90 minutes, further 120 minutes reaction was carried out. Thereafter, the resin which was cooled to room temperature and precipitated was filtered and washed with ion-exchanged water (10 times with ion-exchanged water in an amount of 10 times with respect to the resin) Thereafter, neutralization was sufficiently performed using a 0.3% by mass sodium hydroxide solution, and further, the mixture was washed 10 times with an ion-exchanged water in an amount of 10 times with respect to the resin, dehydrated, and dried to obtain a vinyl butyral resin.

The vinyl butyral resin obtained above was melt-kneaded in the same manner as in Example 1 to obtain a melt-kneaded product. Various physical properties were evaluated using the obtained melt-kneaded product. Table 2 shows the results.

### Comparative Example 6

A vinyl butyral resin was obtained in the same manner as in Comparative Example 5, and a melt-kneaded product was obtained in the same manner as in Comparative Example 7, except that 30 parts by weight of triethyleneglycol-di-2-ethylhexanoate was added as a plasticizer per 100 parts by weight of vinyl butyral resin. Various physical properties were evaluated using the obtained melt-kneaded product. Table 2 shows the results.

### Comparative Example 7

According to the method described in Example 1 of JP201157737A, 100 g of polyvinyl alcohol having an ethylene content of 15 mol %, a saponification degree of 98 mol %, and an average polymerization degree of 1700 was stirred in 900 g of distilled water, but polyvinyl alcohol was not dissolved and an aqueous solution of polyvinyl alcohol having a concentration of 10% by weight could not be obtained, and an acetalization reaction could not be carried out.

### Comparative Example 8

A modified vinyl acetal resin was obtained by a method changed according to Example 1 of the specification of the present application for reaction conditions such as using a polyvinyl alcohol and a n-butylaldehyde having an ethylene content of 15 mol %, a saponification degree of 98 mol %, and an average degree of polymerization of 1700 described in Example 1 of JP201157737A, and using a 1-propanol as a solvent. The obtained modified vinyl acetal resin had an acetalization degree of 73 mol %, which was not consistent with an acetalization degree of 64.5 mol % described in JP201157737A. On the other hand, the obtained modified vinyl acetal resin had an acetal unit of 62 mol % and was approximated to an acetalization degree of 64.5 mol % described in JP201157737A.

From this, it is considered that the degree of acetalization in JP201157737A represents the ratio of the acetalized vinyl alcohol unit to the acetal unit described above, that is, the total monomer unit, and JP201157737A uses an acetalization degree different from the degree of acetalization in the present invention.

Then, a melt kneaded product was obtained in the same manner as in Example 1 of JP201157737A. Various physical properties were evaluated using the obtained melt-kneaded product. Table 2 shows the results.

TABLE 2

| | | Comparative Example | | | | | | |
|---|---|---|---|---|---|---|---|---|
| | | 1 | 2 | 3 | 4 | 5 | 6 | 8 |
| Ethylene | Ethylene unit (mol %). | 15 | 38 | 40 | 44 | 0 | 0 | 15 |
| vinyl | Vinyl alcohol units (mol %) | 85 | 62 | 60 | 56 | 100 | 100 | 85 |
| alcohol | MFR(g/10 min) | 1.5 | 1.7 | 3.2 | 5.5 | — | — | 1.5 |
| copolymer | | | | | | | | |
| Reaction | Ethylene vinyl alcohol copolymer | 100 | 100 | 100 | 100 | — | — | 100 |
| conditions | (parts by weight) | | | | | | | |
| | 1M hydrochloric acid (parts by | 40 | 40 | 40 | 40 | — | — | 40 |
| | weight) | | | | | | | |
| | N-butyraldehyde (parts by weight) | 62.1 | 32.8 | 2.3 | 37.7 | — | — | 60.0 |
| | Sodium carbonate (parts by weight) | 6.4 | 6.4 | 6.4 | 6.4 | — | — | 6.4 |
| | Reaction time (hours) | 8 | 14 | 45 | 8 | — | — | 8 |
| Modified | Degree of acetalization (mol %/PVA | 76 | 55 | 4 | 70 | 72 | 72 | 73 |
| vinyl | unit) | | | | | | | |
| Acetal | Ethylene unit (mol %). | 15 | 38 | 40 | 44 | 0 | 0 | 15 |
| resin | Vinyl alcohol units (mol %) | 20 | 28 | 58 | 17 | 28 | 28 | 23 |
| | Acetal unit (mol %). | 65 | 34 | 2 | 39 | 72 | 72 | 62 |
| | MFR(g/10 min) | 45 | 23 | 15 | 51 | 0.6 | 0.6 | 45 |
| Resin | Plasticizer (phr) | None | None | None | None | None | 30 | None |
| composition | MFR(g/10 min) | 45 | 23 | 15 | 51 | 0.6 | 15 | 42 |
| Sheet-like | Penetration energy (J) | 8 | 10 | 15 | 16 | 14 | 15 | 8 |
| composite | Storage modulus (MPa)@50° C. | 26 | 30 | 890 | 5 | 1,800 | 4 | 28 |
| | Film formability | A | A | A | A | B | A | A |
| Laminated | Haze (%) | 1.2 | 1.4 | 8.5 | 1.1 | 1.2 | 1.2 | 1.5 |
| glass | Maximum shearing stress (MPa/m²) | 19 | 21 | 29 | 17 | 25 | 26 | 19 |

1. A glass laminate comprising an interlayer made of an ethylene-vinyl acetal resin composition, wherein:
(i) the ethylene-vinyl acetal resin composition comprises 80% or more by mass of a modified vinyl acetal resin component, based on the total mass of the ethylene-vinyl acetal resin composition;
(ii) the modified vinyl acetal resin component is one or more ethylene-vinyl acetal resins containing from 25 to 60 mol % of ethylene units and 24 to 71 mol % of vinyl alcohol units, based on all monomer units constituting the resin, and having an acetalization degree of from 5 mol % or more to less than 40 mol %; and
(iii) the glass laminate exhibits a creep of less than 1.9 mm at 60° C. for 1 month.

2. The glass laminate of claim 1, wherein the ethylene-vinyl acetal resin composition is substantially free of plasticizer.

3. The glass laminate of claim 1, wherein the ethylene-vinyl acetate resin composition comprises a plasticizer in an amount of 20% by mass or less, based on the total mass of the resin composition.

4. The glass laminate of claim 1, wherein the ethylene-vinyl acetyl resin(s) contain acetyl groups, and the acetyl groups are derived from one or more of butyraldehyde, benzaldehyde and isobutyraldehyde.

5. The glass laminate of claim 1, wherein the resin composition comprises a heat-shielding material as an additive.

6. The glass laminate of claim 5, wherein the heat-shielding material is one or both of a heat-shielding fine particle or a heat-shielding compound.

7. The glass laminate of claim 1, wherein the interlayer comprises an extruded film or sheet of the ethylene-vinyl acetal resin composition.

8. The glass laminate of claim 7, wherein a structure is provided on at least one surface, or on both surfaces, of the interlayer.

9. The glass laminate of claim 8, wherein the structure is an embossed structure.

10. The glass laminate of claim 1, which is an overhead glazing.

11. The glass laminate of claim 1, which is a spandrel.

12. The glass laminate of claim 1, which is a fin.

13. The glass laminate of claim 1, which is a bolted glazing.

14. The glass laminate of claim 1, wherein the ethylene-vinyl acetal resin composition comprises plasticizer in an amount of 0 to 1% by mass or less, based on the total mass of the resin composition.
